(19) United States
(12) Patent Application Publication
(10) Pub. No.: US 2009/0060257 A1
(43) Pub. Date: Mar. 5, 2009

(54) WATERMARKING METHOD RESISTANT TO GEOMETRIC ATTACK IN WAVELET TRANSFORM DOMAIN

(75) Inventors: Heung Kyu LEE, Seoul (KR); Choong Hoon LEE, Seoul (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: KOREA ADVANCED INSTITUTE OF SCIENCE AND TECHNOLOGY, Daejeon (KR)

(21) Appl. No.: 11/847,041

(22) Filed: Aug. 29, 2007

(51) Int. Cl. G06K 9/00

(52) U.S. Cl. 382/100

(57) ABSTRACT

The present invention relates, in general, to a watermarking method resistant to a geometric attack in a wavelet transform domain, and, more particularly, to technology for embedding a watermark in a discrete wavelet transform (DWT) domain, thus extracting autocorrelation (AC) peaks, which play an important part in the estimation of geometric attacks in ACF-based watermarking, and detecting watermarks using the AC peaks even after geometric distortion is applied. In the watermarking method of the present invention, a watermark pattern is embedded in subbands of a Discrete Wavelet Transform (DWT) domain. An Autocorrelation Function (ACF) of a watermark is executed in the domain, thus detecting a watermark required to estimate a geometric attack. A watermark signal is detected using an undecimated wavelet transform so as to compensate for an image shift in the watermark.

### BACKGROUND OF THE INVENTION

1. Field of the Invention

The present invention relates, in general, to a watermarking method resistant to a geometric attack in a wavelet transform domain. More particularly, the present invention relates to technology for embedding a watermark in a Discrete Wavelet Transform (DWT) domain, thus extracting AutoCorrelation (AC) peaks, which play an important part in the estimation of geometric attacks in Autocorrelation Function (ACF)-based watermarking.

2. Description of the Related Art

Geometric attacks are recognized as one of the strongest attacks for digital watermarking technology. Although a plurality of watermarking techniques for handling geometric attacks has been introduced, they have problems. Autocorrelation Function (ACF)-based watermarking is well known to have the greatest potential to withstand geometric attacks and typical signal processing attacks. ACF-based watermarking can cope with geometric attacks by embedding a periodic watermark pattern. Due to this periodicity, periodic peaks are detected in the ACF of a watermark. A watermark detector determines the applied geometric transform with reference to the peak pattern of the ACF of an extracted watermark. A watermark signal is detected after the determined geometric transform is inverted. Because of this detection mechanism, the detection of precise AC peaks, as well as a watermark signal, is important for the detection of the watermark. However, there is a problem in that, since AC peaks are not sufficiently robust, they can be easily eliminated.

Due to such a geometric attack determination mechanism, watermark embedding and detection in ACF-based watermarking have been executed in the spatial domain. Even if transform domain watermarking requires higher computational complexity than spatial domain watermarking, it is generally known that transform domain watermarking is more robust than spatial domain watermarking. Therefore, when ACF-based watermarking can be executed in a transform domain, improved robustness can be achieved.

In particular, in order to enable ACF-based watermarking to be executed in a frequency domain, the embedding of a watermark in a frequency domain must form periodic AC peaks in a spatial domain. It is not easy to satisfy this requirement using full-frame transform, such as a Discrete Cosine Transform (DCT) or a Discrete Fourier Transform (DFT). The reason for this is that variation in each transform coefficient influences the entire image. However, unlike the full frame transform, a Discrete Wavelet Transform (DWT) has spatial-frequency locality. This means that the embedding of signals in the wavelet coefficient locally influences the image. Therefore, it can be predicted that periodicity in the wavelet coefficient can also be extracted from the spatial domain.

That is, as shown in FIG. 1, when a periodic signal is embedded in the wavelet subbands of a Lena image, the ACF of the signal extracted from the spatial domain is obtained, and periodic peaks can be detected, as predicted above.

### SUMMARY OF THE INVENTION

Accordingly, the present invention has been made keeping in mind the above problems occurring in the prior art, and an object of the present invention is to provide an ACF-based watermarking method operated in a DWT domain, which embeds a watermark in the DWT domain, thus extracting AC peaks, which play an important part in the estimation of geometric attacks in ACF-based watermarking.

In order to accomplish the above object, the present invention provides a watermarking method, comprising a first step of embedding a watermark pattern in subbands of a Discrete Wavelet Transform (DWT) domain; a second step of executing an Autocorrelation Function (ACF) of a watermark in the domain, thus detecting a watermark required to estimate a geometric attack; and a third step of detecting a watermark signal using an undecimated wavelet transform so as to compensate for an image shift in the watermark.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing an example of AC peaks of a Lena image in which a watermark is embedded in a DWT domain;

FIGS. 2A and 2B are graphs showing peak strengths obtained by embedding a periodic watermark in a first level wavelet subband before and after JPEG compression;

FIGS. 3A and 3B are graphs showing peak strengths obtained by embedding a periodic watermark in a second level wavelet subband before and after JPEG compression;

FIG. 4 is a diagram showing a procedure of embedding a periodic watermark in a DWT domain;

FIG. 5 is a diagram showing an example of peaks for a geometric transform estimation algorithm;

FIG. 6 is a diagram showing an image decomposition procedure based on a shift 4 algorithm;

FIG. 7 is a diagram showing a correlation-based detection procedure in a second level subband;

FIG. 8 is a graph showing the distribution of AC peaks after 50% quality JPEG compression;

FIGS. 9A to 9C are graphs showing the histograms of watermark detection responses, which show, in detail, detection response histograms in a DWT first level subband, a DWT second level subband, and a spatial domain, respectively;

FIGS. 10A and 10B are graphs showing theoretical distribution models of detection responses and AC peaks, which show, in detail, a distribution model of detection responses from the DWT second level and a distribution model of AC peak strengths of DWT watermarking;

FIGS. 11A and 11B are graphs showing the ROC curves of AC peak detection and watermark detection after 50% quality JPEG compression; and

FIG. 12 illustrates pictures showing test images for a watermark detection test according to an embodiment of the present invention.

### DESCRIPTION OF THE PREFERRED EMBODIMENTS

Hereinafter, embodiments of the present invention will be described in detail with reference to the attached drawings.

The technical characteristics of the present invention are achieved by embedding a periodic watermarking pattern in a DWT domain and by estimating geometric attacks using the ACF of a watermark in a spatial domain, as in the case of ACF-based watermarking. Further, the present invention is technically characterized in that a watermark signal is detected using an undecimated wavelet transform so as to compensate for image shift when the watermark is detected.

1. Watermarking Algorithm

1) Embedding of Watermark in DWT Domain

In the present invention, a method of embedding a watermark in a DWT domain is described. First, in order to determine the embedding strength for each subband level, the strength of AC peaks is tested according to the level of the subband in which a watermark is embedded.

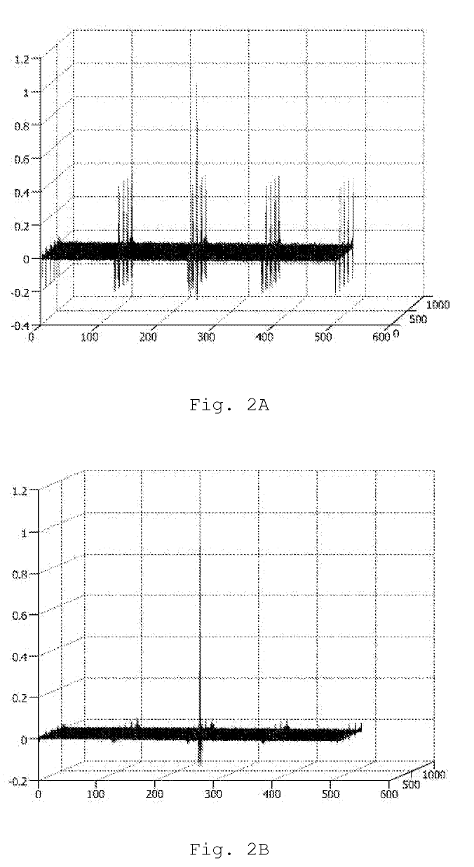

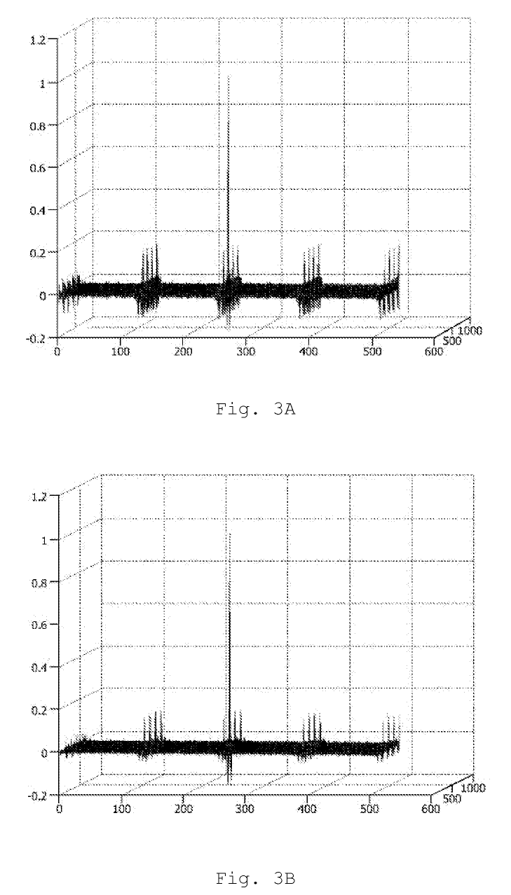

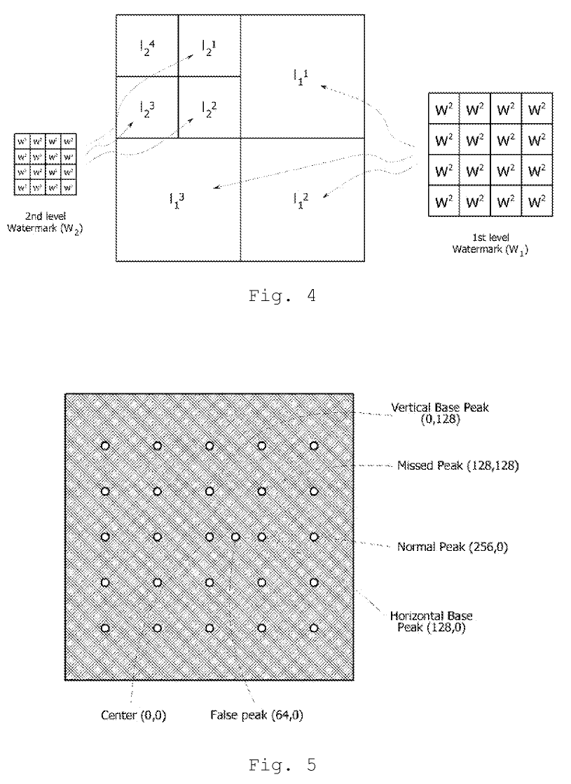

FIGS. 2A and 2B illustrate peak strengths obtained when a periodic watermark is embedded in a first level subband. As shown in FIGS. 2A and 2B, the strength of initial peaks is very high. However, after JPEG compression, the strength of the initial peaks is greatly decreased. In contrast, in the case of second-level embedding, the strength of initial peaks is less than that of the first-level embedding, as shown in FIG. 3, but peak strength is not greatly decreased after JPEG compression.

In conclusion, when a displayed image is not attacked or is weakly attacked, the AC peaks generated by the first-level embedding can be expected to play an important part in the estimation of geometric attacks. However, when a strong attack is applied to the displayed image, the peaks generated by the second-level embedding will play an important part. Therefore, in order to achieve maximum results, the watermark is embedded both in the first level and second level subbands.

FIG. 4 illustrates an embedding structure according to the present invention. An image is decomposed up to two levels through a DWT. In FIG. 4, I_{θ}^{j} is a jth subband in a θ direction (θ=1: horizontal direction, 2: diagonal direction, and 3: vertical direction). In order to embed a watermark in two levels of subbands, two different periodic watermarks are generated. In order to obtain a period of M×M in a spatial domain, a watermark having a period of

$$\frac{M}{{2}^{j}} \times \frac{M}{{2}^{j}}$$

is embedded in a jth subband. For the watermark pattern of the first level subband, a random number sequence having a size of M/2×M/2, which follows a standard normal distribution, is generated using a user key. Using the same method, a basic block having a size of M/4×M/4 is generated for the second level subband. Each watermark block is repeated until the size of a given subband is obtained.

The periodic watermark patterns W₁ and W₂, generated in this way, are embedded in subbands I₁^{θ} and I₂^{θ}, respectively. The watermark is not embedded in a subband I₂⁴, which includes the Direct Current (DC) component of the image. The watermarks are embedded, as indicated by the following Equation [1],

Iⱼ^{θ′}(x, y)=Iⱼ^{θ}(x, y)+αλⱼ^{θ}(x, y)Wⱼ(x, y) [1]

where α and λ are global and local weighting factors, respectively.

Research on a visual masking model for the wavelet transform has already been conducted to some degree. In the present invention, for the local weighting factor, a Noise Visibility Function (NVF) model is applied to a wavelet domain. The NVF is a function of indicating noise visibility in a limited image area using local texture information. The NVF has a higher value in a region in which noise is easily observed. Therefore, the strength of watermark embedding can be controlled using the NVF. Since DWT coefficients include local information, the NVF model can be applied to the DWT domain without change. The NVF in the wavelet domain is calculated using the following Equation [2],

$${NVF}_{j}^{θ} ( x , y ) = \frac{1}{1 + \frac{D}{{σ}_{j max}^{θ2}} {σ}_{j}^{θ2} ( x , y )} \qquad [ 2 ]$$

where σⱼ^{θ2}(x,y) and σⱼₘₐₓ^{θ2} are local variance at location (x, y) and the maximum value of the local variance of the subband in the direction of θ and jth level subband, respectively, and D is a user-defined constant. As the value of D increases, the difference between the NVF values of a plain region and a textured region further increases. Generally, it is well known that visual sensitivity to noise varies according to the direction of subbands. It is more difficult to sense diagonal subband noise than vertical and horizontal subband noise. These features are also used as a parameter for calculating the strength of watermark embedding. The sensitivity based on directionality is defined by the following Equation [3].

$${Θ}^{θ} = \{ \begin{matrix}\sqrt{2} & if 0 = 2 ( diagonal direction ) \\ 1 & otherwise\end{matrix} \qquad [ 3 ]$$

In the present invention, a weighting factor corresponding to a subband level is determined in consideration of expected attack strength. If a watermarked image is not expected to be exposed to strong attacks, a watermark must be more strongly embedded in the first level subband. In contrast, if the watermarked image is expected to be exposed to strong attacks, a higher embedding weight must be assigned to the second level subband. The weighting factor corresponding to a subband level is defined by Lⱼ. In an experiment for performance evaluation, a higher weight is assigned to the second level subband, and thus L₁=0.7 and L₂=1 are set. Consequently, the local weighting factor defined by the following Equation [4] is used,

λⱼ^{θ}(x, y)=LⱼΘ^{θ}[(1−NVFⱼ^{θ}(x, y))·S+NVFⱼ^{θ}(x, Y)·S₁] [4]

where S and S₁ are user-defined weighting factors for a textured region and a plain region, respectively. NVFⱼ^{θ}(x,y), having a value ranging from 0 to 1, has a high value (about 1) in the plain region, and has a low value (about 0) in the textured region. Therefore, in Equation [4], S₁ influences embedding strength in the plain region more than S does. In contrast, S influences embedding strength in the textured region more than S₁ does. Therefore, S must be set to a value higher than S₁. For experiments, S=5 and S₁=1 are set.

2. Watermark Detection Using Undecimated Wavelet Transform

The detection of a watermark according to the present invention is performed through tho two step-detection mechanism of ACF-based watermarking, that is, (1) geometric attack estimation and (2) watermark signal detection.

2-1) Geometric Attack Estimation

Geometric attacks are estimated using AC peaks of an estimated watermark signal. For this procedure, the periodicity of the watermark must be extracted in a spatial domain. Although a watermark is embedded in a transform domain, the periodicity of the watermark can be extracted from the spatial domain using a high sass filter or a noise removal filter, due to the locality of the DWT. In this method, a periodic signal is extracted using a Weiner filter by the following Equation [5],

$${I}^{-} ( x , y ) = μ ( x , y ) + \frac{{σ}^{2} ( x , y ) - {s}^{2}}{{σ}^{2} ( x , y )} ( I ( x , y ) - μ ( x , y ) ) \qquad [ 5 ]$$

where p(x,y) and σ²(x,y) are the local mean and local variance of an original image, respectively, and s² is noise variance. Since noise variance is not available, the average of local variances for s² is used. The extracted signal E is obtained using the following Equation [6].

E=I-I⁻ [6]

Then, the extracted signal E is expected to have periodicity. In order to detect periodicity, the ACF of the extracted signal E is calculated. The ACF is calculated using the following Equation [7] as a FFT-based fast correlation calculation method.

$$ACF = \frac{IFFT ( FFT ( E ) \cdot {FFT ( E )}^{*} )}{{\vert E \vert}^{2}} \qquad [ 7 ]$$

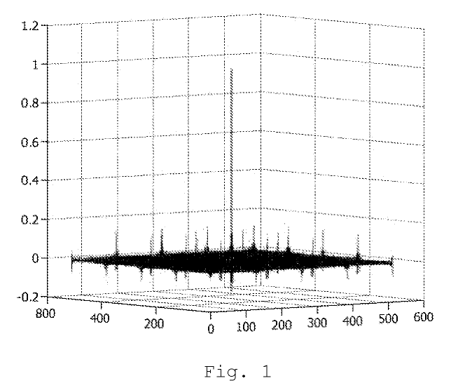

Here, symbol ‘*’ denotes a conjugate complex number. If a test image is indicated as a single image, the periodic peak pattern of FIG. 1 can be seen in the ACF. Geometric attacks are estimated and reversed using an AC peak pattern. The AC peaks are detected in the ACF using an adaptive threshold, as given in the following Equation [8],

ACF(x, y)>μ_{acf}+α_{acf}σ_{acf} [8]

where μ_{acf} and σ_{acf} are the average and standard deviation of the ACF, respectively. α_{acf} must be defined in consideration of false negative and false positive error rates. If it is assumed that the AC values of non-peaks in the ACF follow a normal distribution N(μ_{acf},σ_{acf}), the false negative error rate can be calculated by the following procedure. When an arbitrary variable X indicating standard normal distribution N(0,1) is defined, the probability that an AC value is greater than μ_{acf}+α_{acf}σ_{acf} is equal to the probability that X is greater than α_{acf}. Therefore, when a threshold value is μ_{acf}+α_{acf}σ_{acf}, the false positive error rate for AC peak detection is calculated using the following Equation [9],

$$\begin{matrix}{P}_{fPAC} = P ( {AC}_{non \text{-} peak} > {μ}_{acf} + {α}_{acf} {σ}_{acf} ) \\ = P ( X > {α}_{acf} ) \\ = {\int }_{{α}_{acf}}^{∞} \frac{1}{\sqrt{2}} exp ( \frac{- {x}^{2}}{2} ) d x\end{matrix} \qquad [ 9 ]$$

where P(A) is the probability of an event A, and ACₙₒₙ₋ₚₑₐₖ is an arbitrary variable that follows normal distribution N(μ_{acf},σ_{acf}).

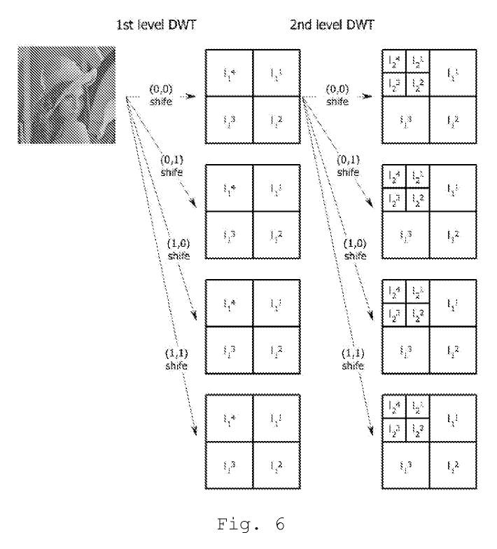

Geometric attacks are estimated by detecting a base peak pair in the detected peaks. In the present invention, the pair of two peaks (vertical and horizontal directions) closest to the center of the ACF is designated as a base peak pair. An example of this is shown in FIG. 5. The watermark, rotation angle, and period can be calculated using offset information about the base peak pair.

The base peak pair can be obtained through the following procedure. Since peaks are periodically distributed, all other peaks can be obtained in the ACF using offset information about the base peak pair if the base peak pair is known.

For example, when a peak pair existing at locations [(0,128), (128,0)] is a base peak pair, it can be seen that peaks exist at locations (128, 128), (256, 0), and (0, 256). The base peak pair is obtained using this property. For each possible peak pair, the number of peaks that can be found using the peak pair is counted. This number is designated as a peak count for a given peak pair. Then, the peak pair having the largest peak count value, among the peak pairs, can be selected as a base peak pair. This method is effective in a typical situation, but may cause errors in some cases. For example, it is assumed that false peaks are detected in the above peak detection procedure.

In FIG. 5, a false peak exists at location (0, 64). In this case, when a base peak pair is selected using the above procedure, the peak pair at locations [(0,64),(128,0)] is selected as the base peak pair because all of the peaks that can be found through the peak pair at locations [(0,128),(128,0)] can also be found through the peak pair at locations [(0,64), (128,0)]. In order to avoid this problem, another term, “peak ratio,” is introduced in the present invention. The term “peak ratio” means the ratio of the number of actually obtained peaks to the number of expected peaks.

Peak ratio=Peak Count/Expected Peak Count [10]

The expected peak count (the number of expected peaks) for a peak pair can be calculated with reference to the size of an image and the offset of the peak pair. For example, it is assumed that an experimental peak pair exists at locations [(0,128), (128,0)] in an image having a size of 512×512. When the experimental peak pair is a base peak pair, an ideal ACF must have

$$\frac{512}{128} \times \frac{512}{128} = 16$$

peaks. Therefore, the expected peak count for the experimental peak pair is 16.

On the basis of the peak count and peak ratio, the base peak pair can be obtained using the following Equation [11] which defines another term “weighted peak count”.

Weighted Peak Count=Peak Count×Peak Ratio [11]

Then, the peak pair having the highest weighted peak count is selected as a base peak pair.

In the above example, although the peak count of the peak pair at locations [(0,128),(128,0)] is less than the peak count of the peak pair at locations [(0,64),(128,0)] by 1, the peak ratio is about twice that of the peak pair at locations [(0,64),(128,0)]. Therefore, the peak pair at locations [(0,128),(128,0)] is selected as the base peak pair.

Finally, geometric attacks, such as rotation, scaling and aspect ratio change, are estimated and reversed using offset information about the selected base peak pair.

2-2) Watermark Signal Detection

A watermark signal is detected from the DWT subbands of a geometrically restored image. The above-described geometric attack estimation method does not handle image shifts. Therefore, in the present invention, a watermark must be detected in consideration of all possible image shifts. In a spatial domain method, this operation can be effectively executed using the FFT-based correlation calculation.

The problem is the fact that a DWT is not shift-invariant. That is, a shift in a spatial domain does not entail a shift in a DWT domain. Therefore, when a watermarked image is shifted, the image must be transformed by DWT on all possible shifts in order to detect a watermark. For this operation, a lot of computational time is required.

Various types of research on shift-invariant wavelet transform have been conducted. The most widely known access method is an undecimated wavelet transform. Typically, the shift-variant property of the wavelet transform is caused by a decimation process. After the wavelet transform has been performed, two subbands are formed. Each subband has a size half of that of an original signal. Since a decomposed subband has only half the resolution of the original subband, the decomposed subband cannot represent all shifts in the spatial domain. If a certain signal is shifted by an odd offset, the result of the wavelet transform of the shifted image is completely different from that of the wavelet transform of the original signal. However, if the signal is shifted by an even offset, the result of the wavelet transform is the shifted version of the result of the wavelet transform of the original signal.

Through these characteristics, an undecimated DWT can achieve shift invariance. For example, when two versions are obtained for the result of the wavelet transform of a single signal (one obtained by directly transforming the signal and the remaining one obtained by shifting the signal by an odd offset and transforming the shifted signal), all possible (even and odd) shifts in the spatial domain can be represented by shifting the subbands corresponding to one of the two transform versions. A shift 4 algorithm is an undecimated DWT extended to two dimensions. The shift 4 algorithm generates four wavelet transform results from a non-shifted image, an image shifted by one pixel in a horizontal direction, an image shifted by one pixel in a vertical direction, and an image shifted by one pixel in a diagonal direction, respectively. All possible shifted images in the spatial domain can be represented using the four transform results.

In order to detect a watermark in the shifted image, the watermarked image is decomposed up to the second level by the shift 4 algorithm. After first level decomposition has been performed, four transformed images are obtained. A low subband in each transform result is transformed again by the shift 4 algorithm. Consequently, 16 transform results are obtained. This process is shown in FIG. 6. All possible shifts can be represented in the spatial domain by shifting the subbands corresponding to one of the 16 transform results using a suitable offset. The embedded watermark is detected from the first and second level subbands in each transform result.

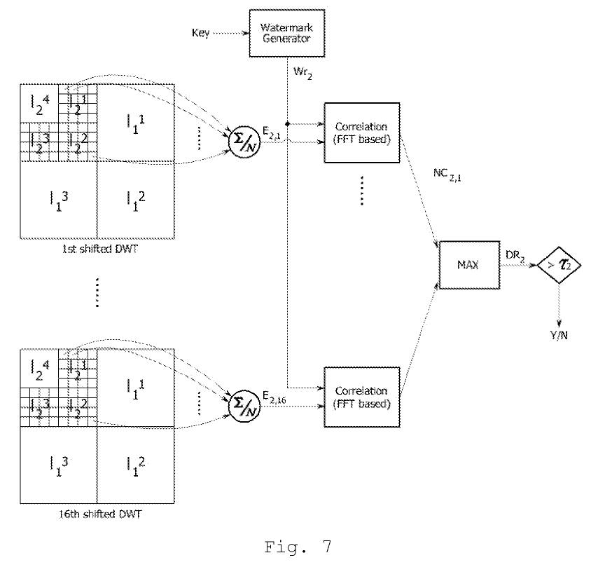

FIG. 7 illustrates a detection procedure in a second level subband. First, a subband including a watermark signal is segmented by a basic pattern size (in the second level, M/4×M/4, and in the first level, M/2×M/2). In each transform result, the average of all segments is calculated. The watermark is detected by calculating a correlation between a segment average E_{j,k} and a reference watermark pattern Wrⱼ while applying all possible shifts to the segment average E_{j,k}. Here, k is a DWT transform result index (the second level satisfies 1≦k≦16, and the first level satisfies 1≦k≦4). This process is executed within a short period of time using FFT by the following Equation [12].

$$N {C}_{j , k} = \frac{IFFT ( FFT ( {E}_{j , k} ) \cdot {FFT ( {Wr}_{j} )}^{*} )}{\vert {E}_{j , k} \vert \vert {Wr}_{j} \vert} \qquad [ 12 ]$$

Among all possible shifts in all transform results, only a single shift is valid, and the correlation value between two signals is maximized on this valid shift. Therefore, the maximum correlation (detector response) is obtained among all possible shifts for each subband level, as shown in the following Equation [13],

$${DR}_{j} = {max}_{x , y , k} \{ {NC}_{j , k} ( x , y ) \} \qquad [ 13 ]$$

Finally, the determination of watermark detection is performed by the following Equation [14].

DR₁>τ₁ or DR₂>τ₂ [14]

τⱼ=μ_{ncj}+α_{ncj}σ_{ncj} [15]

In this case, τⱼ is the threshold calculated by Equation [15], and μ_{ncj} and σ_{ncj} are the average and standard deviation of NC_{j,k}, respectively. α_{ncj} is a user-defined value and is set in consideration of false positive and false negative error rates in watermark detection. Unlike AC peak detection, watermark detection is performed using the maximum value of correlation values. Therefore, a method of calculating a false positive error rate differs slightly. If it is assumed that the correlation values between an unwatermarked block and a reference pattern follow a normal distribution, the probability that each correlation value is higher than the threshold can be calculated using the same method as that of Equation [9] (this probability is designated as P_{fPNC}). The probability that the maximum value of the correlation values is higher than the threshold value is equal to 1-P (the probability that all correlation values are lower than the threshold). Therefore, the false positive error rate is calculated using the following Equation [16],

P_{fp}_{ₘₐₓ}=1-(1-P_{fPNC})^{R} [16]

where R is the number of correlation values. Although computational time is reduced through the undecimated wavelet transform, a considerable amount of computational work is still required because 16 DWT transforms are required on the entire image. However, computational time can be further decreased by reordering the detection procedure. In the original detection procedure, the watermarked image is decomposed by the shift 4 algorithm. Thereafter, the resultant subbands are segmented, and the average of segments (blocks) is obtained. Since a DWT is a linear transform, this procedure can be reordered by the following sequence. That is, (1) the image is segmented into blocks, and the average of the blocks is obtained. (2) The obtained average block is transformed by the shift 4 algorithm. Such a reordering procedure is adapted to reduce the size of input data of the DWT, thus greatly decreasing the computational time.

In the reordering method, the watermarked image is segmented into M×M size blocks (b₁,b₂, . . . ,b_{N}). Then, the average of the blocks is calculated using the following Equation [17].

$${b}_{avg} ( i , j ) = \frac{1}{N} {\sum }_{n = 1}^{N} {b}_{n} ( i , j ) , ( 1 \leq i , j \leq M ) \qquad [ 17 ]$$

Thereafter, the average block b_{avg} is transformed up to the second level by the shift 4 algorithm. Further, in the present invention, E_{j,k} can be calculated by averaging subbands in three directions (horizontal, vertical and diagonal directions) in each level (j) of each transform result (k). In this case, the watermark can be detected, as given in Equations [12] to [14]. Such a reordered detection method produces the same results as the above-described original method. The original method transforms the entire image through the shift 4 algorithm, but the reordered method transforms a block having an M×M size, thus greatly decreasing the computational time.

3. Experimental Results

In the present invention, the performance of a proposed watermarking method is evaluated through experiments. Through experiments, the AC peak strength, watermark signal detection responses, and watermark detection performance, obtained after geometric distortion and removal attacks are applied, are tested.

In order to compare the proposed method with the spatial domain watermarking method, the latter method is modeled using the following Equation [18] and is then compared therewith,

I′=I+α_{S}λ_{S}W_{S} [18]

where α_{S} and λ_{S} are global and local weighting factors, respectively. A NVF-based weighting factor is used for λ_{S}.

λ_{S}=(1−NVF)·S+NVF·S₁ [19]

The NVF is calculated in the spatial domain in the same method as that of Equation [2]. W_{S} is a periodic watermark pattern having a 128×128 period. The basic watermark block is a random number sequence having a standard normal distribution. During the detection of a watermark, geometric attacks are estimated using the same method as that of the proposed method. After estimation has been performed, the extracted signal E in Equation [6] is restored into its original shape. The restored signal is segmented into 128×128 blocks, and the average of the blocks is obtained. The watermark is detected using the maximum correlation between the average block and the reference watermark pattern, as in the case of the proposed method. In this case, the FFT-based correlation calculation is also used.

In the proposed method, watermark patterns of 64×64 and 32×32 sizes are embedded in the first and second level subbands, respectively, so as to obtain a period of 128×128 in the spatial domain.

3-1) Time Complexity Analysis

Since the proposed method and the spatial domain method estimate geometric distortion using the same method, only the computational times at the watermark signal detection step are compared herein. In the reordered detection method, the proposed method has four DWTs of M×M size blocks (first level decomposition) and 16 DWTs of M/2×M/2 size blocks (second level decomposition).

In order to compute the correlation, three FFTs are required for each E_{j,k}. Since the orders of the complexities of FFT and DWT of an N×N size block are O(N²logN) and O(N²), respectively, the computational time generally required for watermark signal detection is given in the following Equation [20].

$$4 {M}^{2} + 16 {( \frac{M}{2} )}^{2} + 3 \times 4 \times {( \frac{M}{2} )}^{2} log ( \frac{M}{2} ) + 3 \times 16 \times {( \frac{M}{4} )}^{2} log ( \frac{M}{4} ) = 8 {M}^{2} + 3 {M}^{2} ( log M - log 2 ) + 3 {M}^{2} ( log M - log 4 ) = 6 {M}^{2} log M - {M}^{2} \qquad [ 20 ]$$

Since the spatial domain method requires three FFTs of M×M size blocks to detect a watermark signal, the approximate computational time required for the spatial domain method is 3M²log M.

Therefore, the computational time required for watermark signal detection in the proposed method is longer than the computational time required for watermark signal detection in the spatial domain method, but the two methods have the same time complexity of O(M² log M).

If the geometric attack estimation step is considered, this computational time difference may be very small. In order to compute ACF at the geometric attack estimation step, three FFTs of an image having an X×Y size are required. Therefore, the computational time in this procedure is about 3XY(logX+logY). Since x, y>>M, the watermark signal detection step occupies a minor part of the overall computational time. Therefore, when the overall detection procedure is taken into account, the difference between the computational times of the two methods can be considered to be very small. Moreover, since M is fixed in the watermarking system, the difference is constant.

3-2i) Robustness Test of AC Peaks and Watermark Signal

In the present invention, the robustness of AC peaks and a watermark signal are tested. Since the geometric attacks are estimated using AC peaks, robustness to the geometric attacks can be predicted by testing the strength of AC peaks.

The strengths of the AC peaks and the watermark signal are tested after JPEG compression. JPEG compression is one of the most widely known watermark attacks. For this test, 700 picture images (having a 512×512 size) arbitrarily collected from the Internet were used. The images were watermarked according to the proposed method and the spatial domain method, and the average Peak Signal to Noise Ratio (PSNR) of the watermarked images was determined to be 38 dB.

The PSNR between an original image I having an X×Y size and a watermarked image I′ is calculated using the following Equation [21].

$$PSNR = 20 {log}_{10} ( \frac{255}{\sqrt{\frac{1}{XY} \sum {( I ( x , y ) - {I}^{′} ( x , y ) )}^{2}}} ) \qquad [ 21 ]$$

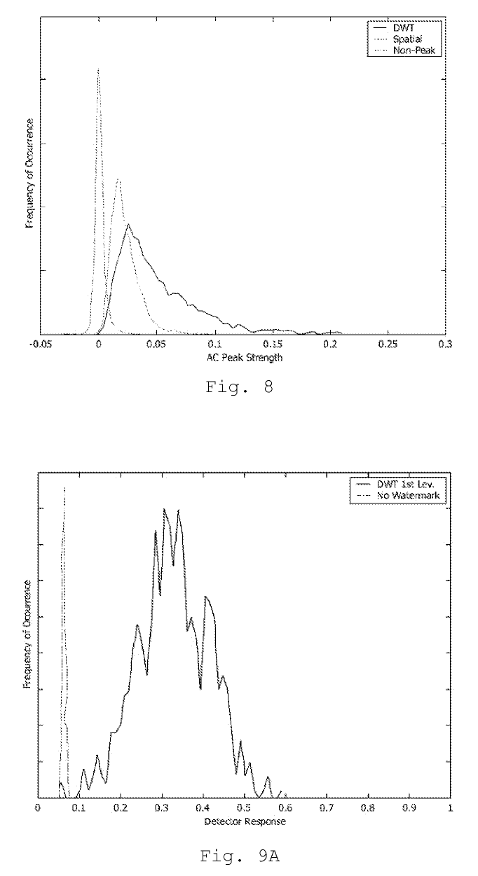

FIG. 8 illustrates the histogram of AC peak values of the two methods after 50% quality JPEG compression. As shown in FIG. 8, in the two methods, the AC peak values are not clearly separated from non-peak values. However, the proposed method exhibits better separation characteristics and higher AC peak values than the spatial domain method. The average peak strengths of the method proposed in the present invention and the spatial domain method are 0.0504 and 0.0228, respectively.

That is, the proposed method can detect AC peaks at an error rate lower than that of the spatial domain method. Consequently, the method proposed in the present invention is expected to exhibit better capability to estimate geometric attacks than the spatial domain method.

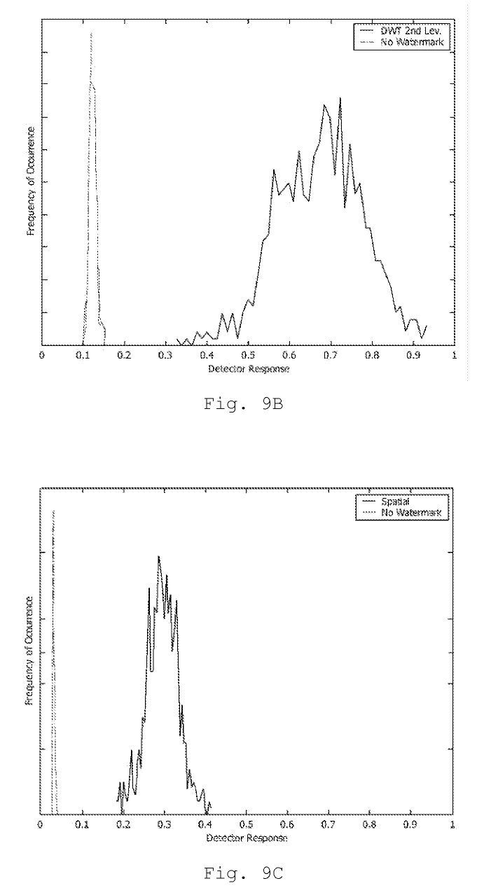

FIGS. 9A to 9C illustrate the histograms of watermark detection responses. Unlike the results of AC peaks, the watermark detection responses show clear separation between the detection responses in the case where a watermark is embedded and the case where no watermark is embedded, except for the results of the first-level subband in the DWT method. Such test results indicate that the spatial domain method can clearly detect the watermark and the proposed method can also satisfactorily detect the watermark in the second level subband.

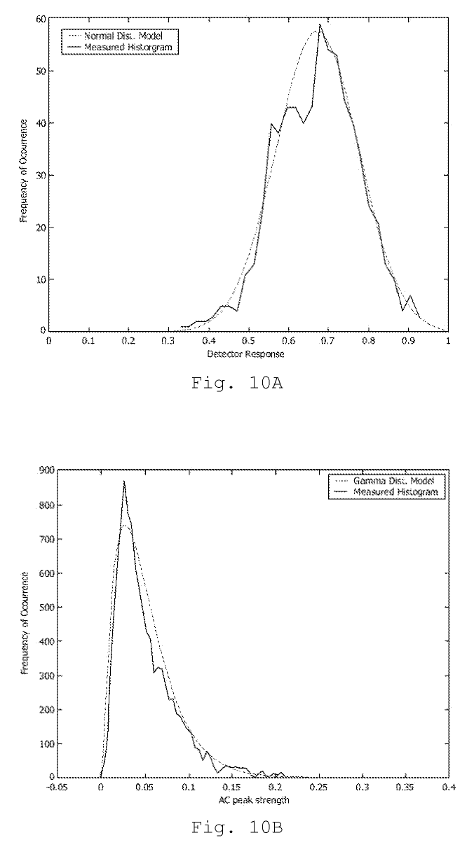

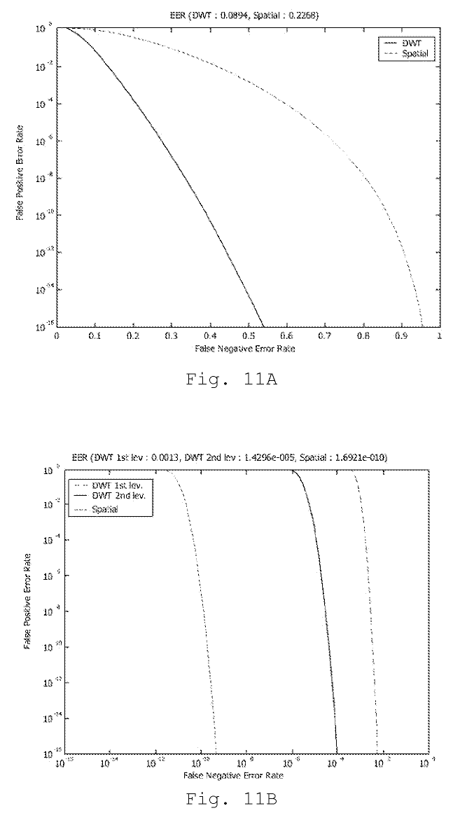

Next, after 50% quality JPEG compression, the error probability of detection of AC peaks and watermark is analyzed using a Receiver Operating Characteristic (ROC) curve. In order to calculate the ROC curve, the theoretical distribution models for respective data items are found. FIGS. 10A and 10B show distribution models for watermark detection responses and AC peak strength. In FIGS. 10A and 10B, it can be seen that histograms measured for watermark detection responses follow normal distribution models. Further, it can be seen that, unlike the watermark detection responses, AC peak strength follows a gamma distribution model rather than a normal distribution model. Through the same method, watermark detection responses obtained from an unwatermarked image and the AC values of non-peaks follow normal distribution. The ROC curve is calculated using the theoretical distribution models obtained in this way.

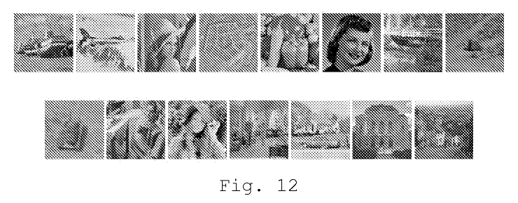

FIG. 11A and 11B illustrate ROC curves for AC peak detection and watermark detection after 50% quality JPEG compression. In FIGS. 11A and 11B, it can be seen that the DWT domain method exhibits much lower error probability of AC peak detection than the spatial domain method. The Equal Error Rate (EER) of AC peak detection in the DWT domain method (0.0894) is less than half the EER in the spatial domain method (0.2268) (where the term “EER” means an error rate when a false positive error rate is equal to a false negative error rate).

In contrast, the error rate of watermark detection in the proposed method is slightly higher than that of watermark detection in the spatial domain method. The proposed method exhibits better detection responses in the second level subband than the spatial domain method, as shown in FIG. 9, but exhibits poorer ROC curves. The reason for this is that the variance of watermark detection responses is higher than that of the spatial domain method. However, the error rate of the DWT domain method in the second subband level is still very low in spite of JPEG compression (EER≈1.43×10⁻⁵).

In general, the error probability of AC peak detection is much higher than that of watermark signal detection. Therefore, success in watermark detection depends more on the detection of AC peaks than on the detection of the watermark signal.

As shown in the above results, the proposed method exhibits stronger AC peaks than the typical spatial domain method, and, consequently, the proposed method can be expected to exhibit better watermark detection performance after geometric attacks are applied.

3-3) Watermark Detection Test Against Geometric Attacks

In the present invention, the results of actual watermark detection, after combined geometric-removal attacks are applied, are described. As a tool for the geometric attacks, a StirMark benchmarking tool has been used. The StirMark tool provides various geometric attacks, that is, row-column removal (5), cropping (9), flip (1), linear geometric distortion (3), aspect ratio change (8), rotation (16), rotation+scaling (16), scaling (6) and shearing (6) (numbers in parentheses denote the number of attacks in each type).

The 15 images in FIG. 12 are test images used for this test. The images are respectively watermarked by two methods (PSNR=38 dB). StirMark geometric attacks and compression attacks based on 50% quality JPEG compression are applied to the watermarked images. The detection test is conducted on the attacked images.

For detection thresholds, α_{acf} in Equation [8] is set to 3.5 and α_{ncj} in Equation [15] is set to 6. On the basis of these values, the false positive error rates of AC peak detection and watermark signal detection are obtained as values of about 2.3×10⁻⁴ and 1.6×10⁻⁵ by Equations [16] and [19], respectively. The threshold for AC peak detection is set to a slightly low value. The reason for this is that the AC peaks are vulnerable to attacks and that the geometric attack estimation procedure in section 2-1) will be satisfactorily executed even if few false peaks are detected.

TABLE 1

| | DWT | Spatial |
|---|---|---|
| R-C removal (75) | 65 | 57 |
| Cropping (135) | 135 | 134 |
| Flip (15) | 15 | 15 |
| Linear transform (45) | 35 | 31 |
| Ratio Change (120) | 107 | 76 |
| Rotation (240) | 187 | 119 |
| Rotation & Scaling (240) | 194 | 118 |
| Scaling (90) | 65 | 52 |
| Shearing (90) | 78 | 62 |
| Total (1050) | 881 | 664 |

Table 1 shows watermark detection results obtained after the application of StirMark geometric attacks and 50% quality JPEG compression, where numbers in parentheses denote the total number of attacks for each type. For example, in the case of “R-C Removal”, the total number of attacks is 75 because five attacks are applied to 15 images.

For all types of attacks, the method proposed in the present invention exhibits better detection results than the spatial domain method. In all tests, watermark signals remain in the images after attacks are applied, and all detection failures are due to the failure in AC peak detection. Since the method proposed in the present invention can generate stronger AC peaks, it exhibits better detection results after combined geometric-removal attacks are applied. Among a total of 1050 detection tests, the DWT domain method succeeds in 881 tests, whereas the spatial domain method succeeds in 664 tests.

As described above, according to the present invention, a new ACF-based watermarking method has been proposed in the DWT domain. Due to the detection mechanism, typical ACF-based watermarking has been limited to the spatial domain method, but AC peaks can be extracted by embedding a periodic watermark pattern in the DWT domain. Further, AC peak strength for each embedding subband level is measured to embed a watermark and is taken into account in the adjustment of watermark embedding strength, and the watermark signal is embedded in a wavelet subband in consideration of noise visibility.

Further, geometric attacks are estimated using the same method as that of typical ACF-based watermarking. The present invention adopts an undecimated wavelet transform, thus solving the problem of image shifts at the detection step.

Therefore, according to the present invention, stronger AC peaks can be obtained compared to a conventional spatial domain method. Consequently, better detection performance against geometric attacks, in particular, combined geometric-removal attacks, can be obtained than when using the spatial domain method.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A watermarking method, comprising:
a first step of embedding a watermark pattern in subbands of a Discrete Wavelet Transform (DWT) domain;
a second step of executing an Autocorrelation Function (ACF) of a watermark in the domain, thus detecting a watermark required to estimate a geometric attack; and
a third step of detecting a watermark signal using an undecimated wavelet transform so as to compensate for an image shift in the watermark.

2. The watermarking method according to claim 1, wherein, at the first step, a periodic watermark pattern is embedded in a first level subband and a second level subband.

3. The watermarking method according to claim 1 or 2, wherein the watermark pattern is implemented such that an embedding strength thereof is controlled by a Noise Visibility Function (NVF).

4. The watermarking method according to claim 1, wherein, at the second step, the geometric attack is estimated and reversed by detecting Autocorrelation (AC) peaks of an estimated watermark signal.

5. The watermarking method according to claim 1 or 4, wherein, at the second step, the geometric attack is estimated and reversed by finding a base peak pair in detected AC peaks.

6. The watermarking method according to claim 5, wherein, at the second step, the geometric attack, such as rotation, scaling and aspect ratio change, is estimated and reversed using offset information about a selected base peak pair.

7. The watermarking method according to claim 1, wherein, at the third step, the watermark signal is detected in a DWT subband of a geometrically restored image.
